(19) United States
(12) Patent Application Publication
(10) Pub. No.: US 2012/0055983 A1
(43) Pub. Date: Mar. 8, 2012

(54) System and Method for Capturing and Communicating Location Data from a Barcode using a Mobile Device

(75) Inventors: Taylor Wellborn, Amarillo, TX (US); Justin Russ, Amarillo, TX (US)

(73) Assignee: FETCHCO, LLC, Amarillo, TX (US)

(21) Appl. No.: 12/876,990

(22) Filed: Sep. 7, 2010

(51) Int. Cl. G06F 7/00

(52) U.S. Cl. 235/375

(57) ABSTRACT

A system and method for delivering a selection of goods or services to a location is disclosed. In particular, the system comprises a barcode and a server. The bar code can be affixed to a location and can comprise encoded data relating to a location. The server can receive a purchase order from a mobile device capable of reading the barcode. The purchase order can comprise the location and a selection of goods or services. The server can also transmit a delivery order to a computer. The delivery order can comprise the location and the selection of goods.

### BACKGROUND

This disclosure relates to a system and method for capturing and communicating location data from a barcode using a mobile device.

As mobile devices have increased in features and functionality, so have their use in our daily lives. Mobile devices can make and receive phone calls, take pictures, send and receive emails, and even act as GPS receivers. Another function of mobile devices is to access the Internet. Today merchants use the Internet to offer goods and services directly to users. One example of merchants offering goods and services to users is a local pizza restaurant taking food orders for delivery. In such example, the user types his address in a form on the merchant's website, places a food order, and gives payment. Such system works well when the user is at his home or other location with a standard address. However when a user is in a temporary location, communicating location can be difficult. For example, suppose a user wants to order food or other item while at a ballpark using an electronic system. While the user has a floor, section, row and seat number, communicating this can sometimes be confusing to a user. As such, any system that relies on a user to input location is unreliable, and could result in orders being misdelivered.

One current solution to communicating location data automatically is the use of GPS receivers. GPS receivers allow users to receive and communicate location information to mobile and web based applications. However there is also a problem associated with using GPS for location data. While GPS data can give a location accurate within a couple meters, high population density areas such as a ballpark need greater accuracy.

It would therefore be advantageous to implement an improved system and method for capturing and communicating location data.

### SUMMARY

A method for delivering a selection of goods or services to a location is disclosed. The method can include receiving from a mobile device a purchase order comprising a selection of goods or services and barcode data from a barcode, encoded with a location. The method can further include transmitting to a computer a delivery order comprising the location and the selection of goods or services.

Further, a system is disclosed for delivering a selection of goods or services to a location is disclosed. In particular, the system comprises a barcode and a server. The barcode can be affixed to a location and can comprise encoded data relating to a location. The server can receive a purchase order from a mobile device capable of reading the barcode. The purchase order can comprise the location and a selection of goods or services. The server can also transmit a delivery order to a computer. The deliver order can comprise the location and the selection of goods.

Lastly, a computer usable medium having a computer readable program code embodied therein is disclosed. The computer readable program code can be adapted to be executed to implement the method mentioned above, performed by the programmed computer processor.

### BRIEF DESCRIPTION OF THE DRAWINGS

FIG. 1 illustrates an item delivery system.

FIG. 2A illustrates a front view of input and output hardware on a mobile user device.

FIG. 2B illustrates a rear view of input and output hardware on a mobile user device.

FIG. 3 illustrates internal hardware within a mobile user device.

FIG. 4 illustrates a barcode.

FIG. 5 illustrates a memory map of memory.

FIG. 6 illustrates input data.

FIG. 7 illustrates a merchant site.

FIG. 8 illustrates data flow during order recording, processing and storing.

FIG. 9 illustrates a computer screen.

FIG. 10 illustrates a preferred method for delivering a selection of goods or services to a location.

### DETAILED DESCRIPTION

Described herein is a method for capturing and communicating location data. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), numerous programming decisions must be made to achieve the developers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of database design and management having the benefit of this disclosure. Accordingly, the claims appended hereto are not intended to be limited by the disclosed embodiments, but are to be accorded their widest scope consistent with the principles and features disclosed herein.

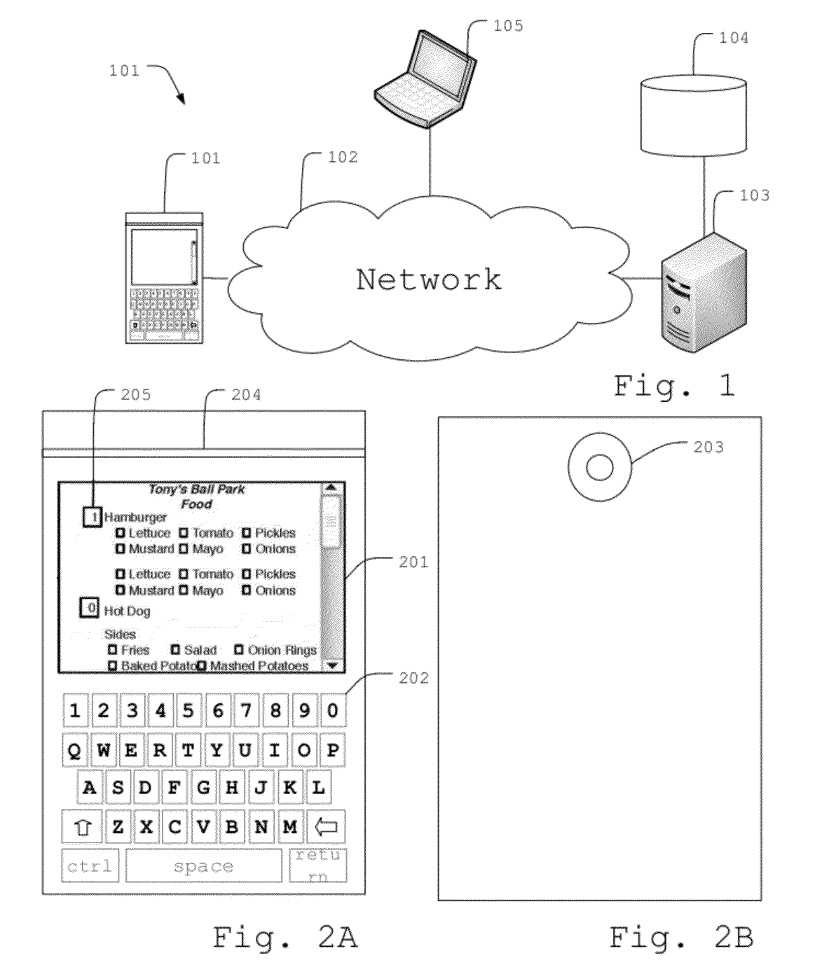

FIG. 1 illustrates an order management system 100 comprising a user device 101, a server 103 and a computer 104. User device can be a mobile device. Within order management system 100 there can exist many user devices 101, each associated with a different user. User device 101 connects a network 102, which can connect to server 103. One illustrative LAN is a network within a single business. One illustrative WAN is the Internet. Server 103 is associated with one or more merchants. Server 103 represents at least one, but can be many servers, each connected to network 102. Server 103 can connect to a storage device 104. Storage device 104 can connect directly to server 103, as shown in FIG. 1, or may exist remotely on network 102. Storage device 104 can comprise any suitable long-term or persistent storage device and, further, may be separate devices or the same device and may be collocated or distributed (interconnected via any suitable communications network). Order management system 100 can also include a computer 105, connected to the network. Computer is associated with a merchant. Computer 105 can include, but is not limited to, a laptop, desktop, workstation, server, mainframe and/or terminal. In one embodiment computer 105 can even be a second mobile user device.

FIG. 2A illustrates a front view of input and output hardware on user device 101. FIG. 2B illustrates a rear view of input and output hardware on user device 101. Input devices can be used to capture input data 205. User device 101 can include, but is not limited to, a screen 201, a keypad 202 and/or a camera 203. Other input devices can include, but are not limited to, track balls, joysticks, or scroll wheels, or even a card reader 204. Screen 201 can be a mere display output, or can also be a touch screen, allowing screen 201 to capture input data 205. Keypad 202 can comprise of a plurality of physical buttons on user device 101, however in an embodiment where screen 201 is a touch screen, keypad 202 can be represented virtually on screen 201. Card reader can read information from a card such as a credit card, driver's license, passport or school ID. Information on a card can be encoded in various ways. Information can be placed on the card in a machine-readable form. Such forms can include a magnetic strip or even a radio frequency identification (RFID) chip. In one embodiment, card reader 203 can read a magnetic strip on the card. In another embodiment card reader 203 comprises a (RFID) chip receiver to read an RFID chip in the card.

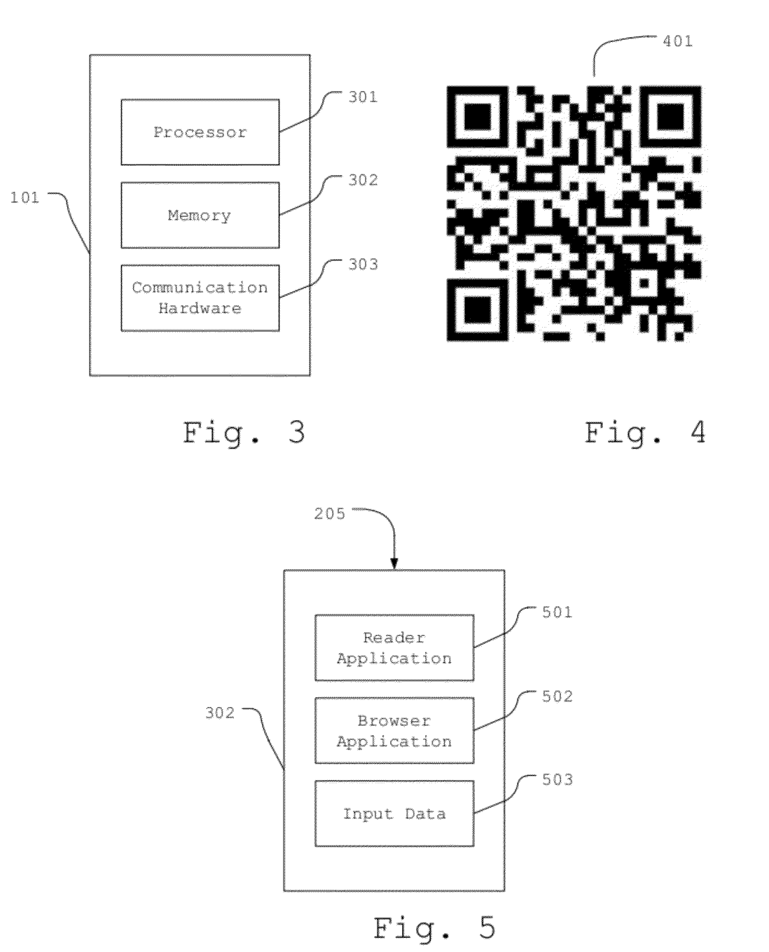

FIG. 3 illustrates internal hardware within user device 101. Input data 205 from is sent to a processor 301. Processor 301 can perform processes on the data according to an application stored in a memory 302, as discussed further below. Processes can include storing input data 205 to memory 302, verifying input data 205 conforms to preset standards, and/or ensuring all required data has been gathered for a process to be complete. For purposes of this disclosure input data 205 can include data which user device 101 may populate automatically, such as date and time, as well as data entered manually. To communicate with network 102, data can be sent to communication hardware 303. Communication hardware 303 can include, but is not limited to, a network transport processor for packetizing data, communication ports for wired communication and/or an antenna for wireless communication.

FIG. 4 illustrates a barcode. Within a delivery area such as a ballpark, many discrete delivery points exist, such as at each seat. As such it becomes necessary to distinguish one deliver point from another. To do so, a barcode 401, which is unique, can be affixed to a location such as a seat, armrest or seat back immediately in front of each seat. In another embodiment, barcode 401 can be on printed collateral, such as an event ticket, which is associated with the seat's location of the user. In such embodiment, the user's arrival at an event location can be noted in the order management system 100 whereupon the printed collateral is redeemed for entry at the event location. Further, in such embodiment, the order management system 100 can automatically enter orders on behalf of the user or send offers to the user at the time of his arrival at the event location. Barcode 401 can be an optical machine-readable representation of data. Barcode 401 can represent input data 205 using the width and spacing of parallel lines (one dimensional) or in patterns of squares, dots, hexagons and other geometric patterns within images (two dimensional), as shown in FIG. 4. Barcode 401 is an example of a two-dimensional bar code called a Quick Response Code (also known as a “QR Code”).

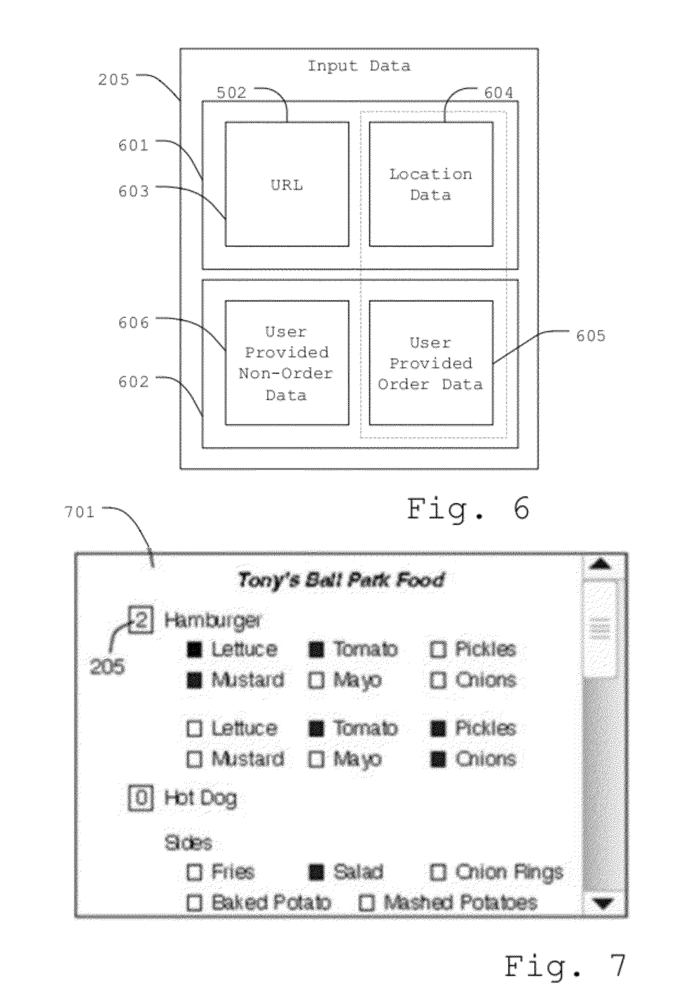

FIG. 5 illustrates a memory map of memory 302. Users with user device 101 having camera 203 can capture barcode 401. Executing a reader application 501 stored in memory 302, user device 101 can then read barcode 401, display input data 205 to screen, store input data 205 in memory 302, connect to a wireless network, execute a browser application 502 stored in memory 302, transmit input data 205 embedded in barcode 401 to browser application 502, and/or open a URL based on the content of input data 205, in browser application 502. This act of linking from barcode 401 is called hard-linking.

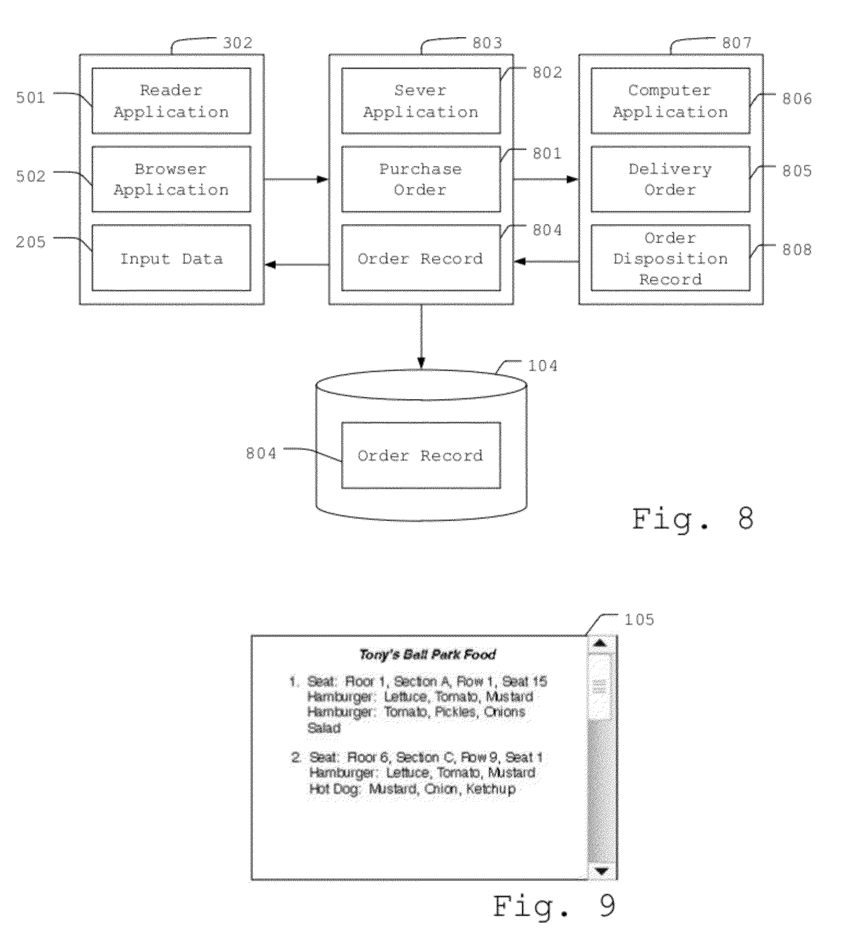

FIG. 6 illustrates input data 205. Input data can comprise bar code data 601 as well as user data 602. Specifically, bar code data 601 can include Uniform Resource Locators (URLs) 603, as well as location data 604 such as a seat position, i.e. floor, section, row and/or seat number, at a ballpark. Input data 205 can include user provided order data 605, and user provided non-order data 606. User provided order data 605 is data related to the good or service that user would like to acquire from merchant and can include, but is not limited to particular goods or services, quantity of goods or services, payment information such as credit card data or check data, and/or time for delivery.

FIG. 7 illustrates a merchant site 701. In one embodiment, barcode 401 can hard-link user device 101 to a web site that allows user to choose between a one or more merchant site 701's. In another embodiment, barcode 401 will hard-link user device 101 to a particular merchant site 701. Merchant site 701 can allow user to choose between various items for purchase. In one embodiment, user can choose who delivers the items. For example, at a ball park or arena, a user may have the option to pay a premium to have a preferred delivery person, such as a cheerleader or mascot, deliver his food. In one embodiment merchant site 701 can include a form for user to fill out. In such embodiment, browser application 502 can auto-fill a portion of the form with input data 205 read from barcode 401, such as location data 604. In another embodiment, merchant site 701 can include a multimedia platform such as Flash, HTML, HTML5, Silverlight, or JAVA to provide interactivity with user.

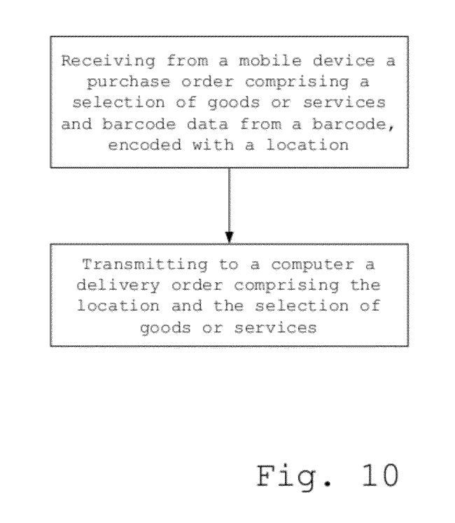

FIG. 8 illustrates data flow during order recording, processing and storing. A purchase order 801 can comprise location data 604 and user provided order data 605. Browser application can send purchase order 801 to a server application 802 existing in a server address space 803 on server 103. Server application 802 can perform various tasks. In one embodiment, server application 802 can verify that purchase order 801 is complete. In another embodiment, suppose a particular merchant has more than one location. Server application 802 can determine, based on location data 604 in purchase order 801, which merchant location should fill purchase order 801.

In one embodiment, server application 802 can record the time and/or date it received purchase order 801. Further server application can combine the time record with at least a portion of purchase order 801 to form an order record 804. Then, server application 802 can store order record 802 in storage device 104. In another embodiment, server application 802 can process payments using payment information in order data 605. In such embodiment, server application 802 can send user a payment confirmation. Server application 802 can also create and send a delivery order 805 to a computer application 806 residing on a computer address space 807, or to a location on the network accessible by computer application 806. Delivery order 805 can comprise location data 604, at least a portion of order data (such as order data without payment information), and/or the time and date server application 802 received purchase order 801. In one embodiment, server application 802 can send delivery order 805 by email. Computer application 806 can be a web browser, a stand-alone application with access to network 102, or any combination thereof. Computer application 806 can perform various tasks. In one embodiment, computer application 806 can record the time and/or date of receipt of delivery order 805. In another embodiment where delivery order comprises payment information, computer application can process payments using payment information. In another embodiment, Computer application 806 can record a time and/or date of delivery to user. Further, computer application 806 can create and transmit to server application 802, an order disposition record 808. Order disposition record 808 can comprise the time and/or date of receipt of purchase order 801 associated with the order, the time and/or date of receipt of delivery order 805, and/or the success or failure of the delivery of goods or services to the user. In one embodiment, if merchant fails to deliver the goods or services, computer application 806 can initiate a return of funds to user. In another embodiment, if merchant fails to deliver the goods or services, server application 802 can initiate a return of funds to user. Server application can 802 can also update order record 804 after receiving order disposition record 808. Such update can include adding the success or failure of the delivery to order record 804. The update can also include adding the date of receipt of the delivery order 805, time and or date of delivery. In one embodiment, server application 802 can match order disposition record 808 with corresponding order record 804 using time and date of receipt of purchase order 801.

FIG. 9 illustrates a computer 105 screen. To facilitate delivery, computer application 806 can display at least a portion of delivery order 805 on the screen of computer 105. In one embodiment, delivery order 805 is transmitted to a plurality of merchants. Further, in another embodiment, the computer application 806 can determine which merchants should receive the delivery order 805 based upon the goods and/or services requested in delivery order 805.

FIG. 10 illustrates a preferred method for delivering a selection of goods or services to a location. First a purchase order is received from a mobile device. The purchase order can comprise goods or services, and barcode data from a barcode. The barcode can be encoded with a location. Then a delivery order is transmitted to a computer. The delivery order can comprise a selection of goods or service, and the location.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. In addition, acts in accordance with FIG. 10 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices, sometimes called computer readable storage medium, suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method for delivering a selection of goods or services to a location comprising
receiving from a mobile device a purchase order comprising a selection of goods or services and barcode data from a barcode, encoded with a location; and
transmitting to a computer a delivery order comprising the location and the selection of goods or services.

2. The method of claim 1 further including the step of placing at a location the barcode encoded with data relating to a location and capable of being read by a mobile device.

3. The method of claim 1 wherein the barcode is also encoded with a uniform resource locator (URL).

4. The method of claim 3 wherein the URL points to a site relating to merchant sites.

5. The method of claim 1 further including the step of printing the barcode, encoded with data relating to a location and capable of being read by a mobile device, on a ticket associated with a location.

6. The method of claim 3 wherein the barcode is a quick response (QR) code.

7. The method of claim 1 wherein the computer is a second mobile device.

8. The method of claim 1 wherein the purchase order further comprises payment information.

9. The method of claim 8 further comprising the step processing a payment using the payment information.

10. The method of claim 1 wherein the purchase order further comprises a choice of deliverer.

11. The method of claim 10 wherein the chosen deliverer receives a portion of a payment for the purchase order.

12. A system for delivering a selection of goods or services to a location comprising
a barcode, wherein the barcode comprises encoded data relating to a location; and
a server that
receives a purchase order from a mobile device capable of reading the barcode,
wherein the purchase order comprises
the encoded data relating to a location; and
a selection of goods or services; and
transmits a delivery order to a computer, wherein the delivery order comprises
the encoded data relating to a location; and
the selection of goods or services.

13. The system of claim 12 wherein the barcode is a quick response (QR) Code.

14. The system of claim 12 wherein the location is a seat at an arena.

15. The system of claim 12 wherein the computer is a second mobile device.

16. The system of claim 12 wherein the purchase order further comprises payment information.

17. The system of claim 16 wherein the server process a payment using the payment information.

18. The system of claim 16 wherein the delivery order further comprises the payment information.

19. The system of claim 18 wherein the computer process the payment information.

20. A computer usable medium having a computer readable program code embodied therein, wherein the computer readable program code is adapted to be executed to implement the method performed by claim 1.
